(19) United States
(12) Patent Application Publication
(10) Pub. No.: US 2025/0041873 A1
(43) Pub. Date: Feb. 6, 2025

(54) HAMMER CAGE

(71) Applicant: Bühler AG, Uzwil (CH)

(72) Inventors: Jörn WEDELE, Insel Reichenau (DE); Michael KÖNIG, Konstanz (DE); Patrick SCHINNERL, Flawil (CH); Pascal REIS, Hefenhofen (CH)

(21) Appl. No.: 18/718,705

(22) PCT Filed: Dec. 7, 2022
(86) PCT No.: PCT/EP2022/084694

§ 371 Date: Jun. 11, 2024

(30) Foreign Application Priority Data
Dec. 16, 2021 (EP) 21215016.3

(51) Int. Cl. B02C 13/28; B02C 13/04

(52) U.S. Cl. CPC B02C 13/28; B02C 13/04; B02C 2013/2808

(57) ABSTRACT

A hammer cage for a hammer mill comprising a main part with a bottom area and slots for positioning hammers in said hammer cage, and said bottom area comprises a surface that prevents any movement of the hammers out of said hammer cage through said bottom area, and wherein said main part further comprises a front and a rear portion with respective openings for releasably arranging said hammer cage in said hammer mill. The present invention is furthermore related to a hammer mill comprising at least one hammer cage.

The present invention is related to a hammer cage for a hammer mill and to a hammer mill comprising at least one such hammer cage.

Hammer mills are well-known from the prior art. Hammer mills are used for coarse comminuting of materials in large quantities. The typical hammer mill has a rotor on which a large number of discs are arranged.

In the circumferential area of the discs, hammer pins are suspended on which hammers are pivotably arranged. When the rotor rotates, these hammers move outwardly in response to centrifugal force, where they break up the material impacting against them. To prevent hammers lined up axially in the direction of the rotor from hitting each other, they are spaced apart by spacers. At the same time, adjacent hammers must be prevented from col-liding in the circumferential direction. The spacers between the hammers are therefore typically different for adjacent axes.

The hammers are subject to severe wear due to the constant impact on material and must therefore be replaced regularly. For this, it is necessary to remove the axle with the spacers and the worn hammers from the machine, separate the worn hammers from the axle, provide new hammers on the axle, and then reinsert the axle in the correct position. This is burdensome and time-consuming.

DE 102 53 345 A1 discloses a hammer mill, in which the replacement of the hammers is simplified, since these can be mounted directly on the rotor in a module. The hammers and their spacers are arranged in a line in a template. A hammer pin is then in-troduced through all lined-up hammers and spacers. The module prefabricated in this manner is then transferred to the rotor in the template and the hammer pin is fixed in the rotor at the rotor discs.

The hammer mills from the prior art have the disadvantage that replacement of an individual damaged or worn hammer is associat-ed with considerable effort. A large number of hammers arranged in front of the hammer to be replaced always have to be removed. Spacers and hammers have to be arranged in a correct sequence.

In DE-10 2014 213 048 A1, a mounting aid for the insertion of hammers into a hammer mill is described. However, this approach has the significant disadvantage that such mounting aids become very heavy with large machines. Also, the replacement of an individual hammer is still burdensome with this solution, since the hammers and spacers are connected via a common axle.

In WO 2011/086035 A2, a hammer assembly is described, wherein several hammers are provided in slits of a rake to laterally guide and position the hammers. In the slits, the hammers can rotate about a hammer pin, but are fixed with respect to lateral displacement. The rakes are connected directly to the rotor discs and segment disks of the hammer mill shown in said docu-ment.

Said solution still is not optimal. For example, the slits of the rake of the assembly of WO 2011/086035 A2 only serve to prevent lateral displacement of the hammers arranged therein, but do not prevent the hammers from being moved downwardly through those slits, which makes assembly of the entire hammer assembly and replacement of worn-out hammers more difficult.

It was the problem of the present invention to overcome the disadvantages of the prior art. In particular, a hammer mill is to be provided which enables simple and quick replacement of the hammers.

This problem is solved by the subject-matter described in the claims of the present invention.

In detail, the present invention is related to a hammer cage for a hammer mill, comprising a main part with a bottom area and slots for positioning hammers in said hammer cage, and said bottom area comprises a surface that prevents any movement of the hammers out of said hammer cage through said bottom area, and wherein said main part further comprises a front and a rear portion with respective openings for releasably arranging said hammer cage in said hammer mill.

According to a preferred embodiment, the present invention is related to a hammer cage for a hammer mill, comprising a main part with a bottom area and side areas, wherein in said side areas slots are provided for positioning hammers in said hammer cage, and said bottom area comprises a surface that prevents any movement of the hammers out of said hammer cage through said bottom area, and wherein said main part further comprises a front and a rear portion with respective openings for releasably arranging said hammer cage in said hammer mill.

According to another preferred embodiment, the main part comprises a top area, wherein in said top area the slots are provided for positioning hammers in said hammer cage. Preferably, between the slots in the top area, intermediate portions are provided which extend from the top area to the bottom area. This embodiment supports the hammers provided in the hammer cage particularly well, and enables a particularly fast replacement of hammers in said hammer cage.

The hammer cage according to the present invention provides several advantages. In said cage, the hammers are fixedly arranged and prevented from being moved downwardly out of the cage. This simplifies assembly of a hammer cage with hammers. Also, the hammer cage comprises a front portion and a rear portion. The hammer cage according to the present invention may be releasably arranged within a hammer mill in various different modifica-tions, without requiring any modification of the hammer mill it-self. Since the hammer cages are designed as a separate component, an almost unlimited number of configuration possibilities can be realized. This gives the operator of a hammer mill many advantages in optimizing his process. Moreover, with the hammer cage according to the present invention worn hammers can be re-used by a simple turnaround method described below.

The hammer cage according to the present invention comprises a main part. Said main part comprises a bottom area. Preferably, said bottom area has a rectangular shape. Said bottom is con-strued such that it prevents any movement of the hammers out of said hammer cage through said bottom area. For said purpose, said bottom area comprises a surface that is impenetrable for the hammers. Preferably, said surface of said bottom area that prevents any movement of the hammers out of said hammer cage through said bottom area is a substantially closed surface, more preferably a flat closed surface. Said surface is preferably of rectangular shape. By “substantially closed” a surface is meant that is either fully closed or may contain openings such as holes of a size that is too small for any hammer to penetrate. For example, the bottom area may comprise small holes or slits having at least one dimension that is too small for any hammer to penetrate through such a hole or slit.

As discussed above, this aids assembly of the hammer cage with hammers, since the hammers are more fixed in said hammer cage.

In one embodiment of the present invention, said main part furthermore comprises side areas. Said side areas are arranged at opposite sides of the bottom area. Preferably, the bottom area has a rectangular shape, and the side areas are arranged at the longer sides of said bottom area.

The side areas of the main part may have any shape that is suitable for securing hammers in slots (discussed below) provided in said side areas. For example, the side areas may be flat rectangular parts that are arranged at the bottom area at a specific angle, preferably of 30-90°, more preferably 90°. In an alterna-tive preferred embodiment, said side areas may have a curved shape, preferably a wave-like shape, with at least one portion that extends over the bottom area of the main part. This struc-ture is preferred, since it provides a better fixation of the hammers arranged in said hammer cage.

In said side areas, slots are provided for positioning hammers in said hammer cage. Said slots are uniformly provided in both side areas of the main part, so that a hammer arranged in a slot of one side area is simultaneously arranged in a respective slot of the other side area. Depending on the shape of the side areas, the slots may or may not extend over the entire height of the respective side area. For example, in an embodiment where the side areas are flat rectangular parts that are arranged at the bottom area at an angle of 90°, the slots preferably extend over the entire height of said side area and are open at their upper end, so as to allow insertion of a hammer from above up to the bottom area. In an embodiment where the side areas have a curved shape, preferably a wave-like shape, with at least one portion that extends over the bottom area of the main part, the slot is preferably only provided in said portion that extends over the bottom area of the main part.

The slots have a width that preferably slightly extends the width of a hammer to be positioned therein. This allows easy insertion of the hammers into the slots, while providing sufficient lateral fixation. Preferably, the slots have a width that extends the width of a hammer to be positioned therein by 1-10%, more preferably 2-5%.

In another embodiment of the present invention, the main part comprises a top area, wherein in said top area the slots are provided for positioning hammers in said hammer cage.

Preferably, the top area has a rectangular shape, and is connected to the front and a rear portion of the main part of the hammer cage.

The top area may be flat or alternatively may have a curved shape, wherein the centre of the top area is elevated as com-pared to the side regions of the top area.

Said slots in said top area are preferably uniformly provided, i.e. the distances between adjacent slots are the same over the entire top area. The slots do not extend over the entire width of the top area, but are laterally closed.

The slots in the top area have a width that preferably slightly extends the width of a hammer to be positioned therein. This allows easy insertion of the hammers into the slots, while providing sufficient lateral fixation. Preferably, the slots in the top area have a width that extends the width of a hammer to be positioned therein by 1-10%, more preferably 2-5%.

Preferably, between the slots in the top area, intermediate portions are provided which extend from the top area to the bottom area.

The intermediate portions comprise openings through which a hammer pin of a hammer mill can be inserted, thus arranging the hammer cage in said hammer mill at an appropriate position. The openings in the intermediate portions are aligned with the openings in the front and a rear portion described below, so that said hammer pin of said hammer mill can be inserted both through the openings in the front and a rear portion and through the openings in said intermediate portions.

The intermediate portions of the main part may have any shape that is suitable for securing hammers in the hammer cage and for allowing connection of the hammer cage with a hammer pin, as described above.

Preferably, the intermediate portions of the main part may be flat parts that are arranged at the top area and the bottom area at an angle of 30-90°, preferably 90°. These flat parts may have a rectangular shape or may have a varying width that decreases from the top area to the bottom area.

In this preferred embodiment, separate sections are formed in the main part of the hammer cage, which separate sections are delimited by adjacent intermediate portions or, in the case of the first and last section, by an intermediate portion and the front portion or the rear portion, respectively. This embodiment supports the hammers provided in the hammer cage particularly well, and enables a particularly fast replacement of hammers in said hammer cage.

According to a preferred embodiment of the present invention, the hammer cage comprises 2-20, preferably 4-15, more preferably 5-10 slots. It should be noted, however, that the present invention is not particularly limited with respect to the number of slots and allows for a broad variation, thus allowing for a plurality of design possibilities.

According to a preferred embodiment of the present invention, the distance between the (adjacent) slots is the same or different and preferably is in a range from 0,5-5 cm, more preferably 1-3 cm. The minimum distance is set such that the hammers do not interfere with each other, when in operation in the hammer mill. The maximum distance is set such that there are no large distances between adjacent hammers, when in operation in the hammer mill. Apart from that, the distances between the slots and thus the distances between adjacent hammers provided in said slots can be varied to a great extent. This allows for an almost unlimited number of configuration possibilities.

Said main part further comprises a front and a rear portion with respective openings for releasably arranging said hammer cage in said hammer mill. These portions delimit the hammer cage longi-tudinally. They comprise openings through which a hammer pin of a hammer mill can be inserted, thus arranging the hammer cage in said hammer mill at an appropriate position. Said front and rear portion are arranged at opposite sides of the bottom area. Preferably, the bottom area has a rectangular shape, and the front and rear portion are arranged at the shorter sides of said bottom area.

The front and rear portion of the main part may have any shape that is suitable for securing hammers in the hammer cage and for allowing connection of the hammer cage with a hammer pin, as described above. Preferably, the front and rear portion of the main part are designed as lugs, respectively.

Preferably, the front and rear portion of the main part may be flat parts that are arranged at the bottom area at a specific angle, preferably of 30-90°, more preferably 90°.

According to a particularly preferred embodiment of the present invention, said main part of said hammer cage is made from a single part. Preferably, said single part is selected from the group consisting of a sheet metal bending part, a sheet metal, a welded or forged steel profile, and wire.

The present invention is not particularly limited with respect to the outer dimensions of the hammer cage. Any size of a hammer cage that allows its arrangement within a hammer mill is suitable. According to a preferred embodiment of the present invention, all hammer cages to be provided in a specific hammer mill have the same dimensions. This allows for a modular design of said hammer mill. According to another preferred embodiment of the present invention, different types of hammer cages with different numbers of hammers can be flexibly combined in a specific hammer mill.

In the hammer cage according to the present invention, hammers are provided that cause a coarse comminuting of materials in a hammer mill, as discussed above. Such hammers are known and do not have to be discussed here in detail.

In the hammer cage according to the present invention, a plurality of hammers can be provided that is limited by the number of slots available in said hammer cage for positioning hammers therein. According to a preferred embodiment of the present invention, one or more, preferably 2-20, more preferably 2-15, and especially preferably 2-7 hammers are provided in the slots.

Said hammers comprise at least one opening, respectively, that is aligned with the openings of the front and rear portion of the main part of the hammer cage when the hammers are arranged within the slots of the hammer cage. This allows for an insertion of a hammer pin of a hammer mill through both the front and rear portion of the main part of the hammer cage and any hammers arranged therein.

With the hammer cage according to the present invention, an operator of a hammer mill can remove and reinsert several hammers at the same time in an easy-to-use holder (i.e. the hammer cage). By inserting a different hammer cage, hammers can be quickly inserted into the machine in a modified configuration. No modification of the machine is necessary. Since the hammer cages are designed as a separate component, an almost unlimited number of configuration possibilities can be realized. This gives the operator of a hammer mill many advantages in optimizing his process.

The hammer cage can already be equipped/prepared outside the hammer mill and then installed as a complete package in the hammer mill. The hammers can be inserted into the hammer cage in the correct distance beforehand. The hammer cages are signifi-cantly lighter than conventional devices, so that they can be installed much faster in hammer mills. This assists in reducing the downtime of a hammer mill for hammer replacement. Hammer packs with different hammer spacing and different numbers of hammers can be installed depending on the application) (e.g. more hammers may be employed for finer granulation). Hammer packs also have more flywheel mass than single hammers.

Moreover, in the hammer cage of the present invention, the hammers are well accessible and can be cleaned easily.

According to a preferred embodiment of the present invention, with the hammer cage of the present invention it is also possible to extend the lifetime of the hammers provided therein. In this preferred embodiment, the hammers comprise at least one additional opening, respectively. Said additional opening can be aligned with the openings of the front and rear portion of the main part of a further hammer cage, when said further additional hammer cage is arranged on said hammers, so that the hammers are arranged within the slots of their hammer cage as well within the slots of the further hammer cage.

The package comprising the hammer cage, the hammers arranged in the slots of said hammer cage, and the further hammer cage with the hammers also arranged in the slots of said further hammer cage can simply be turned around. After removal of the initial hammer cage, the hammers are only positioned in the slots of said further hammer cage, with their non-worn portion protruding out of said further hammer cage.

This easy turnaround of the hammers is possible due to the pro-vision of a surface in the bottom area of the hammer cage that prevents any movement of the hammers out of said hammer cage through said bottom area.

The hammer cage according to the present invention is to be arranged in a hammer mill, as described above.

Hammer mills are generally known from the prior art. The typical hammer mill has a rotor on which a large number of discs are arranged. In the circumferential area of the discs, hammer pins are suspended. The rotor is rotated by a drive, such as a motor.

On said hammer pins, a hammer cage according to the present invention can be pivotably arranged. When the rotor rotates, the hammers in the hammer cage move outwardly in response to centrifugal force, where they break up the material impacting against them. The comminuted material is led through a sieving device that preferably circumferentially surrounds the rotor and leaves the hammer mill through an inlet in the lower region of the hammer mill, whereas coarser material cannot protrude through the sieving device and is transferred to a reservoir below the rotor.

A hammer mill according to the invention has a grinding chamber, which can be closed during normal use, and a rotor described above arranged in the grinding chamber. This rotor comprises a rotor shaft and a plurality of rotor discs, which divide the rotor into a plurality of segments. The rotor discs can be arranged on the rotor shaft at uniform or variable distances from one another. For example, the individual rotor discs can be fixed on the rotor shaft by a screwed connection.

The rotor has a plurality of hammer pins for receiving one or more hammer cages according to the present invention.

The individual hammer pins preferably do not extend over all segments. In said preferred embodiment, the individual hammer pins do not reach over all segments, and it is thus possible to replace the hammer cages in a simple manner.

The hammer pins may also be rotationally symmetrical and can be fastened releasably on both sides to opposite rotor discs defining an individual segment.

Openings in the rotor discs, which can receive the hammer pins, may have an inner diameter which is greater than an outer diameter of the hammer pin. The hammer pin therefore has to be withdrawn completely or in part merely from one opening in the rotor disc. A partially withdrawn hammer pin can then be removed from the segment by being tilted. The opening in the rotor disc is large enough that tilting of the hammer pin is enabled, whereby the hammer pin can be moved past an adjacent rotor disc.

Preferably, the hammer pins of a segment are arranged circumferentially so as to be offset from the hammer pins of an adjacent segment. The hammer pins can thus be released and withdrawn more easily.

One or more segment disks may be arranged between each two adjacent rotor discs. Such a segment disk, which likewise has openings, through which the hammer pin passes or is passed, is used in particular to provide additional support for the hammer pin. In particular at high rotational speeds, the hammer pins are highly stressed by the weight of the hammers and by the rotation of the rotor. The hammer pins can be made accordingly smaller due to the use of segment disks.

The segment disks can be connected to the rotor discs by means of support pins. Such a connection of the segment disks to the rotor discs results in additional stability of the rotor. The support pins may be continuous over all rotor discs. A simple construction is possible as a result of such support pins extending over all rotor discs.

Each hammer pin between each two adjacent segment disks or rotor disks or between a segment disk and an adjacent rotor disc can receive at least one or more hammer cages of the present invention. The number of hammer cages and hammers to be provided therein is determined by the desired type of grinding, the rotational speed, the mass of the individual hammers, and by rotor diameter.

Each hammer pin may be provided at a first end with a cap for fastening the hammer pin in an opening in a rotor disc. Such a cap may be a metal component. The cap may have a substantially cylindrical shape, of which the outer diameter corresponds substantially to the inner diameter of the openings in the rotor discs. The cap is thus received or can be received in the respective opening in the rotor disc with an accurate fit. Such caps are known from WO 2011/086035 A2.

It is also conceivable for the hammer pin to have a second cap at its second end, said second cap being fixedly connectable for example to another rotor disc.

If the rotor of a hammer mill is locked in place using a fixing device, the hammer cage according to the present invention can be replaced by one operator in an easy manner. Such a fixing device is described in WO 2011/086035 A2.

In the hammer mill of the present invention, there may be provided at least one door closing the grinding chamber. The door can be mounted displaceably by means of rollers on a roller track arranged parallel to the rotor axis. The rollers are mounted on roller shafts fastened to the door, said roller shafts extending perpendicular to the roller tracks. The rollers can be mounted axially displaceably on these roller shafts between an open position and a closed position. Such rollers mounted displaceably on the roller shafts allow simple and space-saving release of the door of the hammer mill so that it can then be moved easily to the side. This construction offers high stability without great outlay and without the need for a complicated rotating or hinged mechanism. The rollers can be bi-ased, on the roller shafts, into the open position by a pressing means. Displacement from the closed position is thus facilitat-ed. For example, a spring assembly is a conceivable pressing means. The door may have additional closing means, which allow displacement of the rollers into the closed position, against the force exerted by the pressing means. Such closing means are a simple tension lever for example. Other closing means are also conceivable.

The present invention will now be explained in more detail with respect to non-limiting examples and drawings.

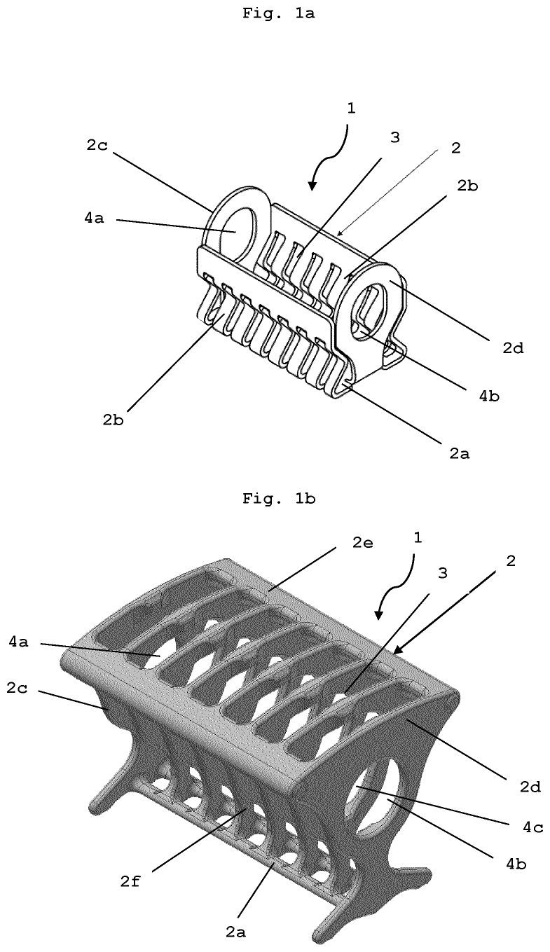

FIG. 1a shows a schematic representation of a first embodiment of a hammer cage according to the present invention.

FIG. 1b shows a schematic representation of a second embodiment of a hammer cage according to the present invention.

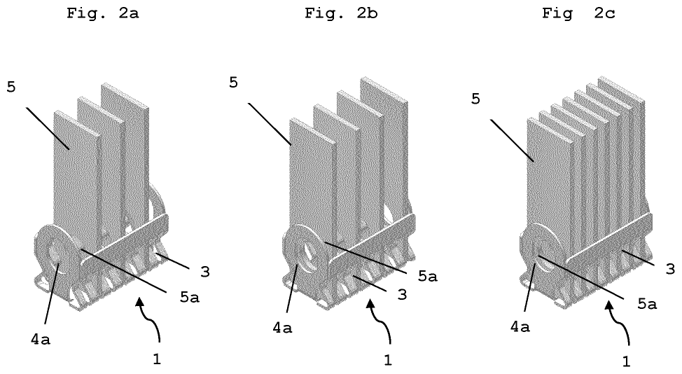

FIG. 2a-c show different configurations of a hammer cage according to the present invention equipped with a different number of hammers.

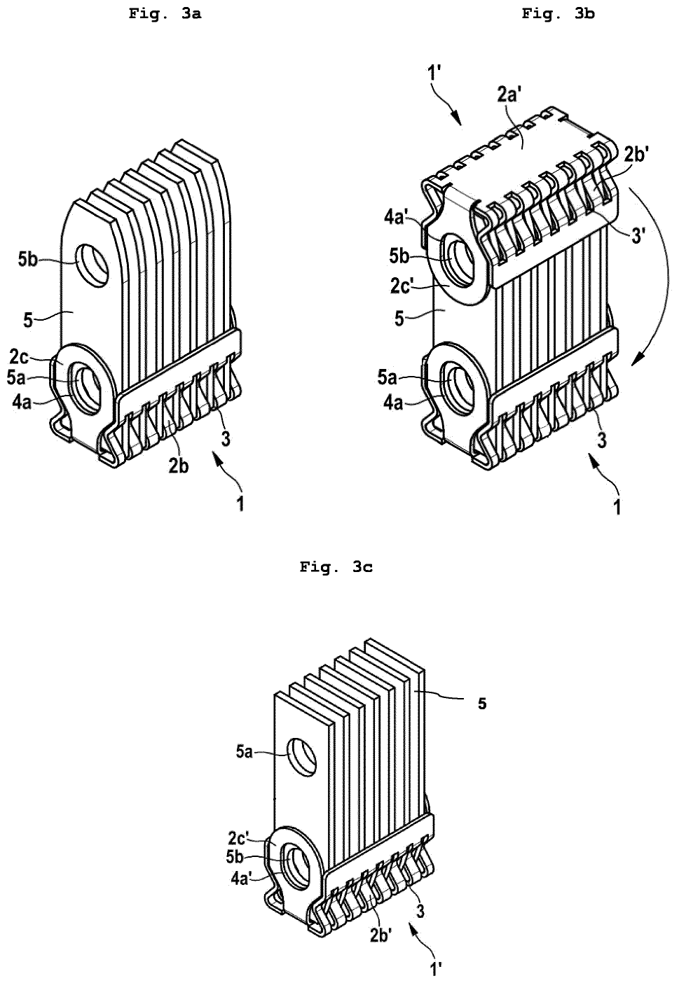

FIG. 3a-c show an embodiment of the present invention of turning worn hammers.

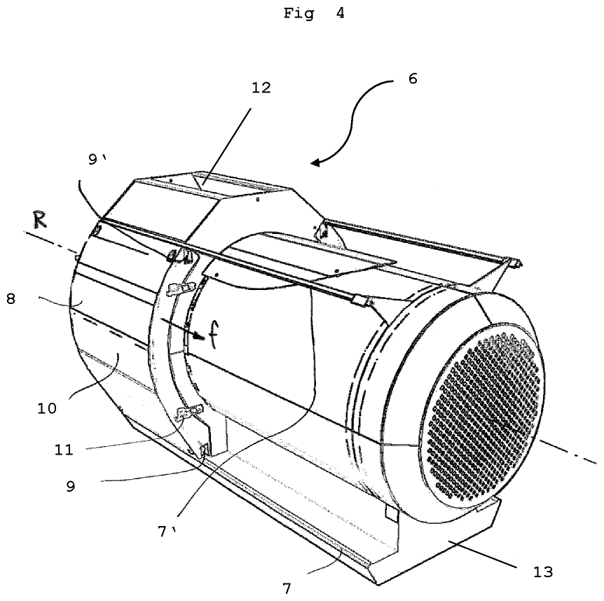

FIG. 4 shows a perspective view of a hammer mill according to the invention.

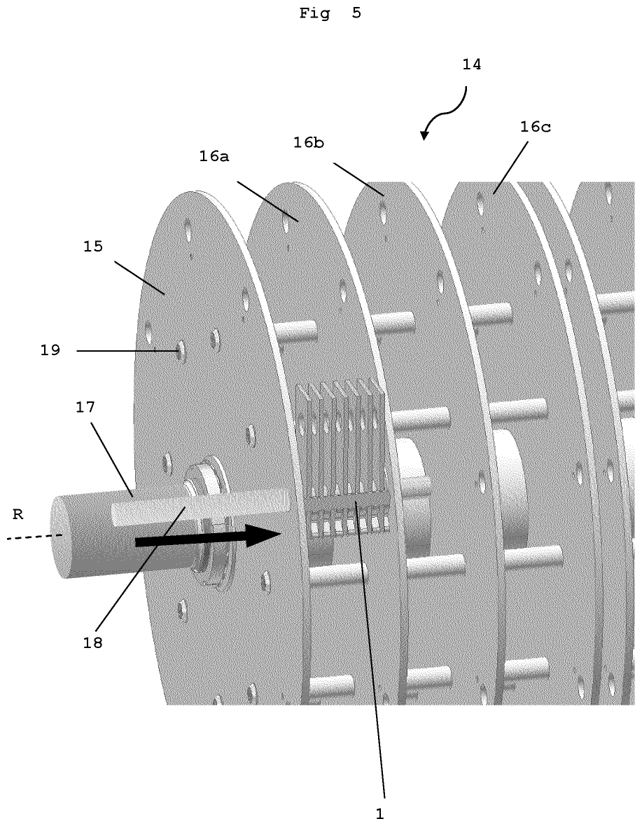

FIG. 5 shows a perspective view of rotor disks and segment disks in the grinding chamber of the hammer mill according to FIG. 4.

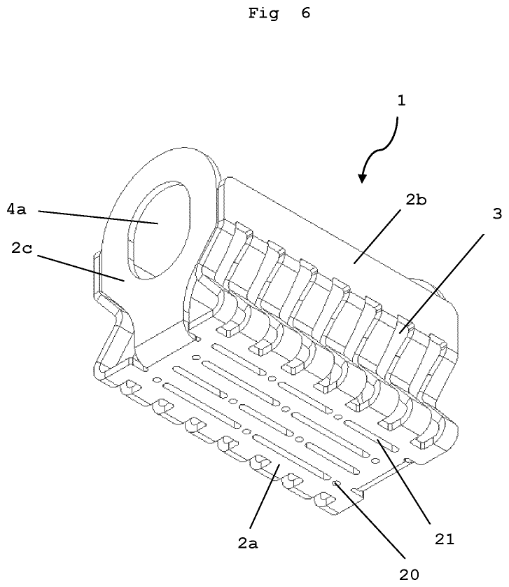

FIG. 6 shows a schematic representation of an embodiment of a hammer cage according to the present invention with openings in the bottom area.

In the drawings, same reference numbers denote the same components.

FIG. 1a shows a schematic representation of a first embodiment of a hammer cage 1 according to the present invention. The hammer cage 1 comprises a main part 2. Said main part 2 comprises a bottom area 2a, which here has a rectangular shape. The bottom area 2a has a substantially closed flat surface with small openings (see FIG. 6). On the longer sides of the bottom area 2a, there are arranged side areas 2b with slots 3 provided therein. The side areas 2b have a wave-like shape, with the slots 3 extending in the portions of the side areas 2b that are arranged above the bottom area 2a.

Said main part 2 furthermore comprises a front portion 2c and a rear portion 2d, which are arranged on the shorter sides of the rectangular bottom area 2a. In said front portion 2c and said rear portion 2d, there are provided openings 4a, 4b for insertion of a hammer pin 18 (not shown here).

In the embodiment of FIG. 1a, said main part 2 is made of a single bent sheet metal plate.

FIG. 1b shows a schematic representation of a second embodiment of a hammer cage 1 according to the present invention. The hammer cage 1 comprises a main part 2. Said main part 2 comprises a bottom area 2a, which here has a rectangular shape. The bottom area 2a has a flat surface with sufficiently small openings so that hammers 5 may not protrude through said openings.

Said main part 2 furthermore comprises a front portion 2c and a rear portion 2d, which are arranged on the shorter sides of the rectangular bottom area 2a. In said front portion 2c and said rear portion 2d, there are provided openings 4a, 4b for insertion of a hammer pin 18 (not shown here).

Said main part 2 furthermore comprises a top area 2e, which here has a rectangular shape with a curved surface. The surface has a saddle-like shape, with the centre thereof being elevated with respect to the side portions of the top area. The top area 2e is delimited by the front portion 2c and the rear portion 2d. In the top area 2e, slots 3 are arranged. The slots 3 are laterally closed.

Between the slots 3, there are provided intermediate portions 2f that extend from (and are connected to) the top area 2e to the bottom area 2b. In this embodiment, the intermediate portions have a flat shape with a width that decreases from the top area 2e to the bottom area 2b. In said intermediate portions 2f, there are provided openings 4c for insertion of a hammer pin 18 (not shown here). The openings 4c are aligned with the openings 4a, 4b in said front portion 2c and said rear portion 2d, so as to allow insertion of a hammer pin 18 (not shown here) through the front portion 2c and said rear portion 2d and said intermediate portions 2f simultaneously.

FIG. 2a-c show different exemplary and non-limiting configurations of a hammer cage 1 according to the present invention equipped with a different number of hammers 5. The embodiment of the hammer cage 1 shown in FIG. 2a-c corresponds to the embodiment shown in FIG. 1a. It is to be understood, however, that the embodiment of the hammer cage 1 shown in FIG. 1a can be used in the same way.

In the embodiment of FIG. 2a, three hammers 5 are positioned in non-adjacent slots 3, i.e. there is one slot 3 each between the hammers 5 which is empty. The hammers 5 each comprise an opening 5a that is aligned with the openings 4a, 4b of the front and rear portion 2c, 2d of the main part 2 of the hammer cage 1.

In the embodiment of FIG. 2b, four hammers 5 are positioned in non-adjacent slots 3, i.e. there is one slot 3 each between the hammers 5 which is empty. The hammers 5 each comprise an opening 5a that is aligned with the openings 4a, 4b of the front and rear portion 2c, 2d of the main part 2 of the hammer cage 1.

In the embodiment of FIG. 2c, seven hammers 5 are positioned in adjacent slots 3, i.e. there is no empty slot 3. The hammers 5 each comprise an opening 5a that is aligned with the openings 4a, 4b of the front and rear portion 2c, 2d of the main part 2 of the hammer cage 1.

FIG. 3a-c show an embodiment of the present invention of turning worn hammers 5. Said hammers 5 are provided in a hammer cage 1 as described above, i.e. with their openings 5a aligned with the openings 4a, 4b of the front and rear portion 2c, 2d of the main part 2 of the hammer cage 1.

In said embodiment, the hammers 5 comprise one additional opening 5b, respectively.

In FIG. 3b, a further hammer cage 1′ is positioned on the free side of the hammers 5, with the openings 4a′, 4b′ (latter not shown) of the front and rear portion 2c′, 2d′ (latter not shown) of the main part 2′ of said further hammer cage 1′ being aligned with said additional openings 5b, respectively. The hammers 5 are arranged within the slots 3′ of the further hammer cage 1′.

As indicated by the arrow in FIG. 3b, the package consisting of the hammer cages 1, 1′ and the hammers 5 arranged therein can then be turned around, so that the hammer cage 1 comes up and the further hammer cage 1′ comes down.

In FIG. 3c, the hammer cage 1 has been removed, so that the hammers 5 are only provided in the further hammer cage 1′. The non-worn side of the hammers 5 now protrudes out of the further hammer cage 1′.

FIG. 4 shows a perspective view of a hammer mill 6 according to the invention. The hammer mill 1 has a rotor (not shown here) equipped with one or more hammer cages 1 (not shown here) according to the present invention. The rotor is located in a grinding chamber, which is surrounded by a housing 10. The housing 10 is designed in such a way that an undesired escape of the mill feed into the external environment is prevented during the operating phase. The drive for the rotor is located on the side of the hammer mill 6 facing the viewer.

At least one door 8 is provided for servicing operations and can be displaced in the direction f for opening. To this end, the door 8 has upper and lower rollers 9 and 9′, which can be rolled over roller tracks 7, 7′ arranged parallel to the rotor shaft during the displacement movement. The roller track 7 assigned to the lower rollers 9 is an integrated component of a machine ta-ble 13 on which the hammer mill 6 is installed. Two roller tracks 7′ in the form of guide bars extending parallel to the rotor axis R are provided for the upper rollers 9′. Furthermore, closing means 11 for securing the door 8 in a closed position can be seen in FIG. 4.

The roller mill 6 according to FIG. 6 comprises an inlet 12 for inserting milling material into the grinding chamber, which is surrounded by a housing 10.

FIG. 5 shows a perspective view of rotor disks 15 and segment disks 16a, 16b, 16c in the grinding chamber of the hammer mill 6 according to FIG. 4. Said grinding chamber is surrounded by the housing 10 of the hammer mill 6 according to FIG. 4.

In the grinding chamber, there is provided a rotor 14. The individual components of the rotor 14 preferably consist of metal materials, preferably of steel. The rotor 14 has a rotor shaft 17 arranged coaxially with the rotor axis R. The rotor has two rotor discs 15 defining end faces, the first of which is visible in FIG. 5. Segment discs 16a, 16b, 16c are arranged between the end-face rotor discs 15, whereby the rotor is divided into segments and further supported. The rotor 14 can have a variety of segments, for example three, four, or more segments, depending on the purpose. The arrangement of a single central segment disc so as to define two segments is also conceivable.

The segment discs 16a, 16b, 16c preferably have a reduced outer diameter in the region of the hammer pins 18 of the adjacent segments, and therefore the hammer pins 18 of an adjacent segment are not impeded by the support rings 16a, 16b, 16c when they are withdrawn. A stable and robust design is achieved, since the segment discs 16a, 16b, 16c are connected to the rotor discs 15 by means of support pins 19. In contrast to the hammer pins 18, the support pins 19 preferably extend over the entire length of the rotor and thus cover all segments of the rotor 14.

Each segment has hammer pins 18 distributed over the circumfer-ence. The individual hammer pins 18 do not have to extend over the entire rotor 14, but preferably only extend over 1-3 segments. For example, the hammer pin 18 may thus extend from the rotor disc 15, merely as far as to the segment disc 16c. Said hammer pins 18 may be inserted through openings in the rotor disc 15, as indicated by the arrow in FIG. 5.

On said hammer pins 18, one or more hammer cages 1 according to the present invention may be arranged, as described above. In FIG. 5, only one rotor cage 1 is shown, for better comprehen-sion. As discussed above, on said rotor 14 there may be arranged a plurality of hammer cages 1, each preferably having the same outer dimensions in order to allow a modular design of the hammer mill. As discussed above, said plurality of hammer cages 1 may have the same or varying distance between the slots 3 of a hammer cage 1.

FIG. 6 shows a schematic representation of an embodiment of a hammer cage 1 according to the present invention with openings 20, 21 in the bottom area 2a. The openings 20, 21 can be either holes 20 or slits 21 that extend in longitudinal direction of the hammer cage 1. The diameter of the holes 20 respectively the width of the slits 21 is such that no hammer may penetrate there through.

1. Hammer cage for a hammer mill, comprising a main part with a bottom area and slots for positioning hammers in said hammer cage, and said bottom area comprises a surface that prevents any movement of the hammers out of said hammer cage through said bottom area, and wherein said main part further comprises a front and a rear portion with respective openings for releasably arranging said hammer cage in said hammer mill.

2. Hammer cage according to claim 1, wherein the main part comprises side areas, wherein in said side areas the slots are provided for positioning hammers in said hammer cage.

3. Hammer cage according to claim 1, wherein the main part comprises a top area, wherein in said top area the slots are provided for positioning hammers in said hammer cage.

4. Hammer cage according to claim 3, wherein between the slots in the top area, intermediate portions are provided which extend from the top area to the bottom area.

5. Hammer cage according to claim 1, wherein said main part is made from a single part, preferably selected from the group consisting of a sheet metal bending part, a sheet metal, and wire.

6. Hammer cage according to claim 1, wherein said surface of said bottom area that prevents any movement of the hammers out of said hammer cage through said bottom area is a surface, preferably a flat surface, comprising openings of a size that is too small for any hammer to penetrate.

7. Hammer cage according to claim 1, wherein the hammer cage comprises 2-20, preferably 4-15, more preferably 6-12 slots.

8. Hammer cage according to claim 1, wherein the front and rear portion of the main part are designed as lugs, respectively.

9. Hammer cage according to claim 1, wherein said hammers comprise at least one opening, respectively, that is aligned with the openings of the front and rear portion of the main part when the hammers are arranged within the slots of the hammer cage.

10. Hammer cage according to claim 9, wherein said hammers comprise at least one additional opening, respectively, that is aligned with the openings of the front and rear portion of the main part of a further hammer cage when the hammers are arranged within the slots of the further hammer cage.

11. Hammer mill, comprising at least one hammer cage according to claim 1.

12. Hammer mill according to claim 11, wherein the hammer mill comprises a plurality of hammer cages, each having the same outer dimensions.

13. Hammer mill according to claim 11, wherein said one or said plurality of hammer cages are provided at a rotor which has a rotor shaft and can be rotated around an axis R.

14. Hammer mill according to claim 11, wherein said one or plurality of hammer cages are provided in said hammer mill on at least one hammer pin.

15. Hammer mill according to claim 14, wherein said at least one hammer pin is provided in opening of a rotor disc and at least one segment disk.
